(19) United States
(12) Patent Application Publication
(10) Pub. No.: US 2007/0091279 A1
(43) Pub. Date: Apr. 26, 2007

(54) Projection display apparatus and method of preventing inadvertent input

(76) Inventors: Chien-Ken Chang, Taoyuan Hsien (TW); Chun-Hao Lee, Taoyuan Hsien (TW); Jung-Yi Yang, Taoyuan Hsien (TW); Bao-Kim Liu, Taoyuan Hsien (TW)

Correspondence Address: Douglas J. Christensen;Patterson, Thuente, Skaar & Christensen, P.A., 4800 IDS Center, 80 South Eighth Street, Minneapolis, MN, 55402, US

(21) Appl. No.: 11/257,189

(22) Filed: Oct. 24, 2005

(51) Int. Cl. G03B 21/20

(52) U.S. Cl. 353/85

(57) ABSTRACT

A projection display apparatus and method of preventing from inadvertently inputting command thereof are provided for preventing users from inadvertently inputting the command to shut down a discharge lamp of the projection display apparatus. The method comprises the following steps: preparing to enter a determination mode when a projection display apparatus receives a activation signal; displaying the predetermined delay time on a screen of the projection display apparatus and down counting such delay time; determining whether a confirmation signal is received during the delay time; and shutting down the discharge lamp when the project display apparatus receives the confirmation signal. If the projection display apparatus fails to receive the confirmation signal or receive other signals during the delay time, the projection display apparatus will return to the normal display mode.

### BACKGROUND OF THE INVENTION

1. Field of the Invention

The present invention relates to a projection display apparatus and methods of preventing inadvertent input, specifically to a projection display apparatus and methods of preventing inadvertent input by using a discharge lamp.

2. Descriptions of the Related Art

FIG. 1 is an internal block diagram of a prior art projection display As shown in FIG. 1, the working theory and manner of the prior art projection display is described as below: An A/V selection switch 61 selects an audio/video signal from one of a first audio/video input (AV1) 53, a second audio/video input (AV2) 55 or a base-band AV input, demodulated by a TV tuner 59, received from an antenna 57. When the A/V selection switch 61 selects the audio/video signal input, the selected audio signal will be transmitted to an audio circuit 65 which amplifies the received audio signal and drives a speaker 67 to play the selected audio signal. Meanwhile, the A/V selection switch 61 transmits the selected video signal to a video circuit 63 which outputs an image, after processing, to be displayed to a display unit 69. A projection discharge lamp 51 emits a light to project the image to be displayed from the display unit 69 to a screen 71. An activation circuit 49 is equipped to activate or shut down the projection discharge lamp 51.

Conventional projection displays are equipped with a remote controller 41 and a control panel 43. Users can use either the remote controller 41 to send an input signal, via a remote receiver 45, to a microcontroller 47, or the control panel 43 by pressing a button to send the input signal directly to the microcontroller 47. If the input signal given by the user is an instruction for power control, the microcontroller 47 will send control signals separately to the video circuit 63 and a control bus 40 to control the video circuit 63 and/or the audio circuit 65 to shut down their functions. The microcontroller 47 will also send the control signal to an activation circuit 49 to shut down a projection discharge lamp 51.

In the projection displays, it requires a lapse of time to re-activate the discharge lamp after the discharge lamp being shut down. The reason for the projection displays to be equipped with remote controllers is to facilitate users for long distance operation. However, the remote controllers have a drawback, that is, the buttons of the remote controllers are usually too small. Furthermore, the pitches between buttons are also too narrow due to a limited panel space of the remote controller. When users operate with the remote controller, it is very easy to press incorrect buttons. For example, when a user wants to change the channels, she/he may press the power button erroneously instead of a desired channel button.

If a conventional display, e.g., a CRT display, is shut down by pressing the unwanted power button, it can be turned on quickly by pressing the power button again. Nevertheless, for projection displays, if the users erroneously press the power button on the remote controller or the control panel to shut down the displays by inadvertent input, a time period will be required for the users to re-activate the projection displays due to the characteristics of the discharge lamp. Such a requirement is certainly inconvenient to the users.

### SUMMARY OF THE INVENTION

An object of this invention is to provide a projection display apparatus which can avoid inadvertent input of pressing a power button on a remote controller or a control panel operated by users.

Another object of this invention is to provide a method of preventing inadvertent input by a confirmation process. When users press an unwanted power button, the display will not shut down a discharge lamp immediately. Instead, the display will shut down the discharge lamp only when the confirmation process is passed.

Yet a further object of this invention is to provide a method of preventing inadvertent input by setting a password protection for input devices of the remote controller and/or the control panel. The password protection can prevent the discharge lamp from being shut down under a careless input condition and waiting for a time period to re-activate the discharge lamp.

In order to achieve the above and other purposes, this invention provides a projection display apparatus with the ability of preventing inadvertent input. The projection display apparatus comprises a display module, a discharge lamp, an activation circuit, and a microcontroller. The display module is configured to receive a video signal and to display an image. The discharge lamp is configured to emit lights to project the image. The activation circuit, coupled to the discharge lamp, is configured to activate and shut down the discharge lamp. The microcontroller is configured to control the display module and the activation circuit according to a control signal. When the microcontroller receives two control signals for shutting down the projection display apparatus, the microcontroller controls the activation circuit to shut down the discharge lamp.

The two control signals are a first signal and a second signal. In general, the first control signal to shut down the power of the projection display apparatus is generated by pressing a power button of the control panel or the remote controller. The second control signal to shut down the power of the projection display apparatus is generated by pressing a specific button, preferably a button different from the power button, of the control panel or the remote controller.

In one embodiment of this invention, the microcontroller starts a counting function for counting a predetermined time period in response to the first control signal. The microcontroller outputs a counting value to the display module to display a counting image and stops the counting function after the counting value is up to the predetermined time period.

Furthermore, this invention provides a method for preventing an inadvertent input to shut down a discharge lamp of a projection display apparatus by a power shut down operation instruction. The method comprises the steps of: receiving a power shut down signal; detecting whether a confirmation signal is received; and shutting down the discharge lamp if the confirmation signal is received.

The receiving step comprises the step of activating a counting function for counting down a predetermined time period. In general, the power shut down signal is the input signal from a power button of a control panel or a remote controller. The confirmation signal is the input signal from a specific button of the control panel or the remote controller, wherein the button is preferably different from the power button.

This invention also provides another method for preventing inadvertently activating a power shut down procedure of a projection display apparatus. The method comprises the steps of: receiving a power shut down signal to activate a password identification procedure; and activating the power shut down procedure if a check status of the password identification procedure is TRUE.

The power shut down procedure comprises the step of shutting down a discharge lamp in advance. The password identification procedure comprises the steps of: presetting the check status to FALSE; setting a predetermined delay time period and counting down the predetermined delay time period; detecting whether an input signal is received within the predetermined delay time period; comparing each assigned character of the input signal with a corresponding indexed character of a password of the power shut down procedure when the input signal is received; exiting from the password identification procedure if the assigned character of the input signal fails to match the corresponding indexed character of the password; and setting the check status to TRUE if every character of the input signal matches the password.

Furthermore, the password identification procedure further comprises the steps of: determining if the projection display apparatus is in a password identification environment; and exiting from the password identification procedure if the projection display is not in the password identification environment

This invention also provides another method for preventing inadvertently shutting down a power of a projection display apparatus. The method comprises the steps of: receiving an activation signal for entering a power shut down procedure; setting a predetermined delay time period; determining whether a confirmation signal is received within the predetermined delay time period; entering the power shut down procedure if the confirmation signal is received within the predetermined delay time period; and resuming to a normal display status of the projection display apparatus if the confirmation signal is not received or a signal different from the confirmation signal is received within the predetermined delay time period.

The power shut down procedure comprises the step of shutting down a discharge lamp in advance. The activation signal and the confirmation signal are inputted by means of buttons of one of a remote controller and a control panel. In one embodiment of the present invention, the confirmation signal is a series of successive inputted characters which matches a password.

In conclusion, the methods of preventing inadvertent input of this invention will confirm again before entering the power shut-down procedure or the discharge lamp shut-down procedure of the projection display apparatus. The confirmation includes a confirmation button pressed by users or a consecutive and correct input of the password to activate corresponding procedure of the projection display apparatus. Consequently, a more safe shut-down procedure for both power and the discharge lamp is provided.

### BRIEF DESCRIPTION OF THE DRAWINGS

FIG. 1 is an internal block diagram of a prior art projection display;

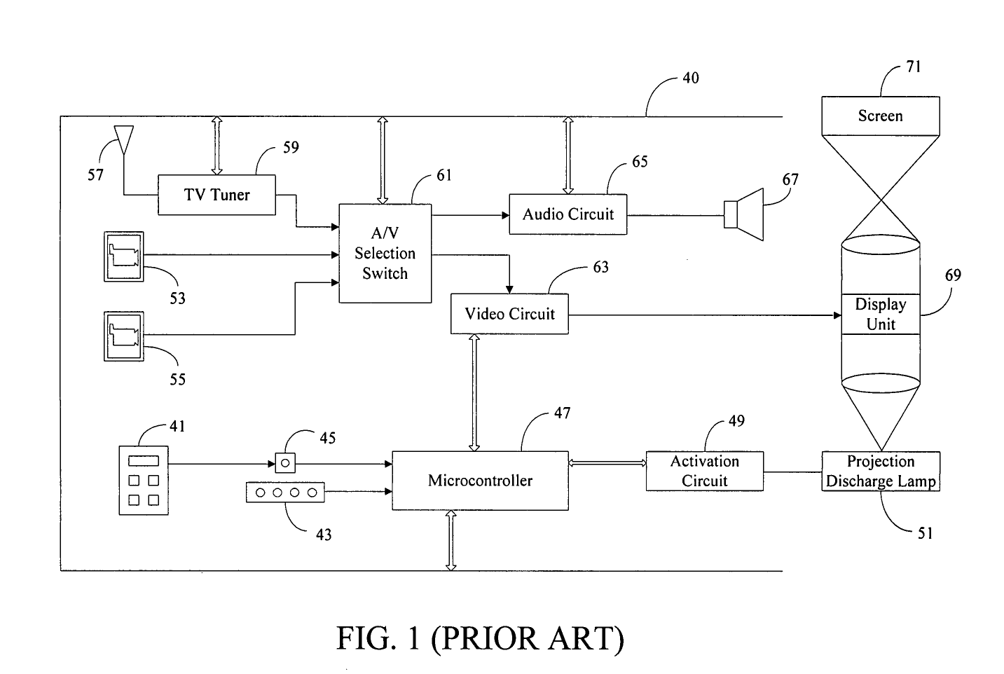

FIG. 2 is a flow chart of a method of preventing inadvertent input for shutting down a discharge lamp according to one embodiment of the present invention;

FIG. 3 is a schematic diagram of the display text on the display screen of the embodiment of the present invention;

FIG. 4 is a flow chart of the countdown procedure in FIG. 2;

FIG. 5 is a block diagram of the projection display apparatus according to one embodiment of the present invention;

FIG. 6 is a flow chart of a method of preventing inadvertent input for shutting down the power according to another embodiment of the present invention; and

FIG. 7 is a flow chart of the password identification procedure in FIG. 6.

### DESCRIPTION OF THE PREFERRED EMBODIMENT

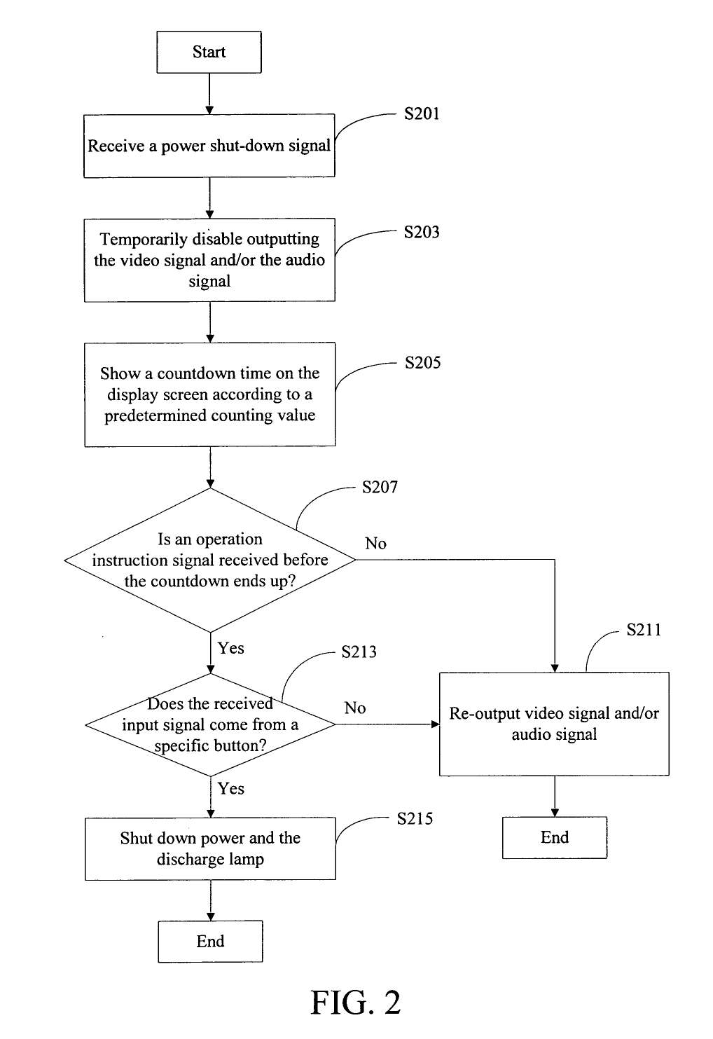

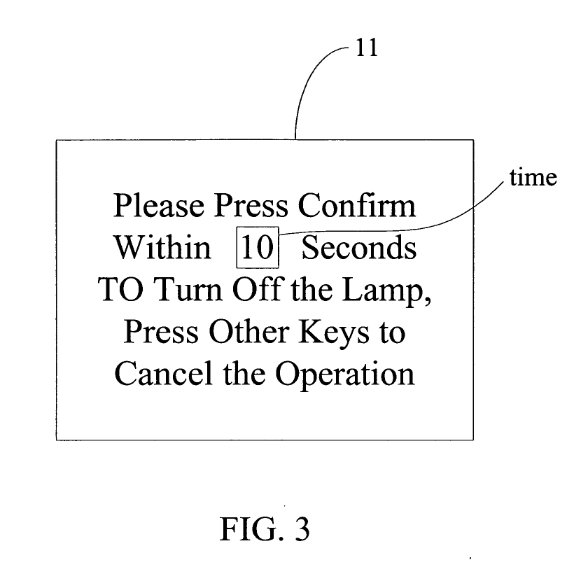

As shown in FIG. 2 and FIG. 3, the embodiment of the present invention will explain how to prevent the projection display apparatus from activating a projection lamp shut-down procedure first, that is, how to prevent the projection display apparatus from shutting down the projection lamp by inadvertent input of users from the remote controller or the control panel. In step S201, when the projection display apparatus receives the power shut-down signal from the remote controller or the control panel, the projection display apparatus neither shut down the whole system nor the discharge lamp. Instead, as shown in step S203, the projection display apparatus will temporarily disable outputting the video signal and/or the audio signal. Later, as shown in step S205, the projection display apparatus shows a countdown time on the display screen according to a predetermined counting value (for example, 10). Please refer to FIG. 3, the displayed text on the display screen 11 of the projection display apparatus shows the countdown time (“time”) which is the number of 10.

The projection display apparatus shows the countdown time of the display screen as shown in FIG. 3. In step S207, the projection display apparatus detects whether an operation instruction signal is received from the remote controller or the control panel before the countdown ends up. If the projection display apparatus has detected the input signal from the button of the remote controller or the control panel (e.g., the “Yes” of the step S207), it enters to step S213. In step S213, the projection display apparatus determines whether the received input signal comes from a specific button, for example, a signal generated from a corresponding “confirm” button being pressed. If the projection display apparatus determines that the received input signal is generated by the specific “confirm” button, it enters to step S215 to shut down both power and the discharge lamp of the projection display apparatus. The specific button in step S213 is a confirm button which can be any buttons of the remote controller or the control panel selected by the manufacturers. Furthermore, if no corresponding signal of said specific button is received in step S213, step S211 will be executed.

If the projection display apparatus has not received the input signal produced by the corresponding button from the remote controller or the control panel (e.g., the “No” of the step S207), that is, the projection display apparatus does not receive any signals from the remote controller or the control panel before the countdown ends up, step S211 will be executed and the projection display apparatus re-outputs the video signal and/or the audio signal.

In other words, when users press the power button, the projection display apparatus determines whether users want to shut down the whole system. If the users does not press the specific button (confirm operation), or press other buttons of the remote controller or the control panel, the step S211 will be executed and the projection display apparatus re-outputs the video signal and/or the audio signal.

Although step S207 to step S215 of one embodiment of the present invention show the operation of the projection display apparatus when the users press any button other than the specific button, it does not represent that the present invention should be designed in this particular way. The major principle of the present invention is that the projection display apparatus cannot be shut down by only pressing the power button. Instead, the specific button should be pressed also to shut down the entire projection display apparatus. Any techniques include such a determination process will match the principle of the present invention.

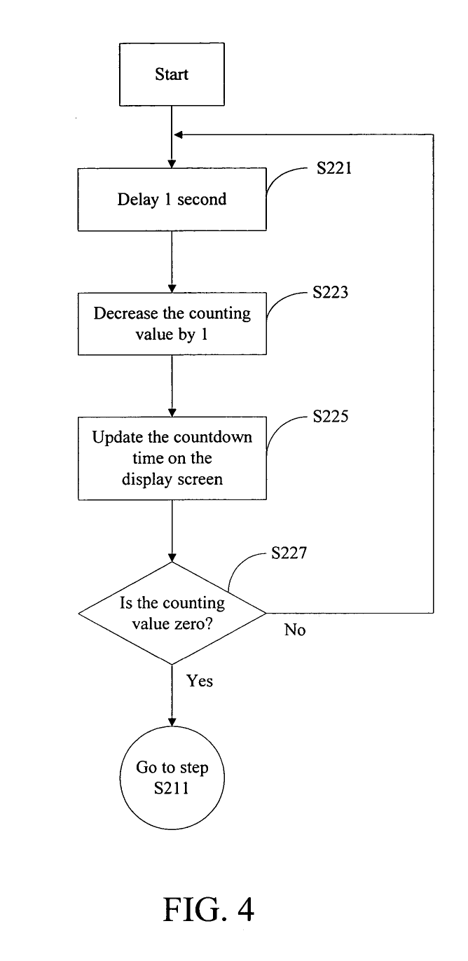

FIG. 4 is a flow chart of the countdown procedure in FIG. 2. As shown in FIG. 4, when the projection display apparatus starts the countdown, a predetermined time interval (1 second in this embodiment) is delayed first as shown in step S221. In step S223, the counting value is decreased by 1. As shown in step S225, the countdown time (“time”) on the display screen 11 of the projection display apparatus in FIG. 3 is updated. In next step S227, the counting value is determined whether it is zero or not. If the counting value is zero, step S211 is executed. If the counting value is not zero, step S221 will be repeated.

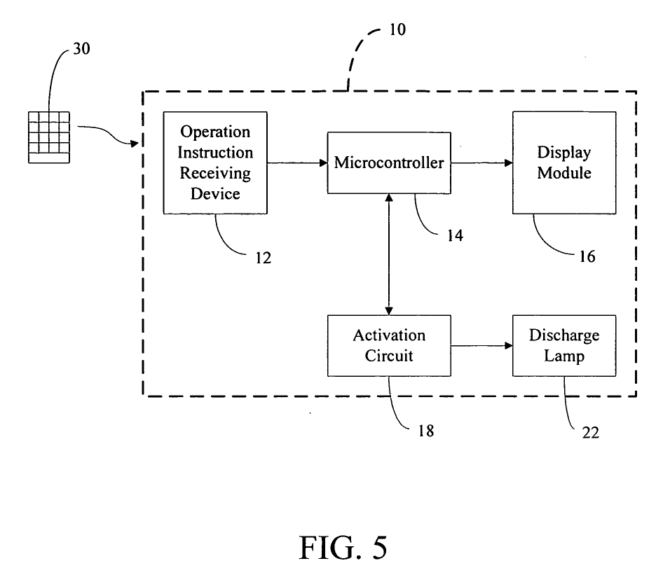

FIG. 5 is a block diagram of the projection display apparatus according to one embodiment of the present invention. The present invention provides a projection display apparatus. As shown in FIG. 5, the projection display apparatus 10 comprises a display module 16, a discharge lamp 22, a microcontroller 14, an activation circuit 18 and an operation instruction receiving device 12, wherein the operation instruction receiving device 12 in the embodiment comprises a remote control signal receiver (not shown) and a control panel 32 (not shown). While implementing the invention, the operation instruction receiving device 12 can be only one of the remote control signal receiver or the control panel 32. When users use the remote controller 30 or the control panel 32 to send out an operation instruction to the projection display apparatus 10, the operation instruction receiving device 12 receives the signal from a button of the control panel 32 or the remote controller 30. In response to the button signal, the operation instruction receiving device 12 sends out a corresponding control signal to the microcontroller 14 to control the image display module 16 and the activation circuit 18.

For example, when the power button of the control panel 32 or the remote controller 30 is pressed to send the power shut-down signal, the operation instruction receiving device 12 will send out the control signal to the microcontroller 14. The microcontroller 14 will then activate a counting function to count down a predetermined time period and outputs the countdown time to the display module 16 for outputting the counting image as shown in FIG. 3. If the specific button of the remote controller 30 or the control panel 32 for confirming the shutting-down the power has been pressed before the countdown time ends up, the operation instruction receiving device 12 generates a confirmation signal to be transmitted to the microcontroller 14 which in turn controls the activation circuit 18 to shut down the discharge lamp 22 and the power of the entire projection display apparatus 10. If the confirmation button is not pressed before the countdown time ends up, no confirmation signal will be generated and sent out. Accordingly, the microcontroller 14 will end up the counting function and recover the original state of the projection display apparatus 10.

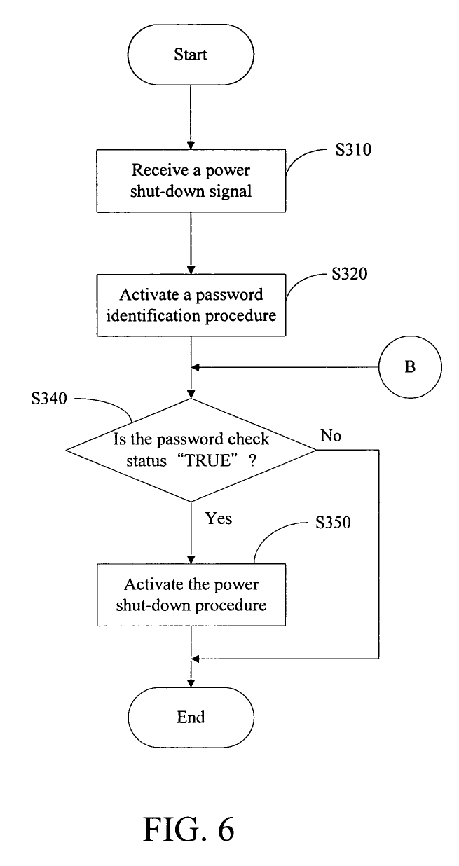

As shown in FIG. 6, the following embodiment will explain how to prevent users from inadvertently activating the power shut-down procedure. In step S310, when users press the power button, the projection display apparatus receives a signal to enter the power shut-down procedure, a password identification procedure as shown in step S320 is then activated. In response to the check status of the password identification procedure, step S340 determines whether the check status is “TRUE.” If the result is “Yes”, the power shut-down procedure is activated as step S350 and ends the method. If the result in step S340 is “No”, the method ends directly without activating power shut-down procedure. The power shut-down procedure of step S350 comprises shutting down the discharge lamp first. In a typical projection display apparatus, the power shut-down procedure may comprise the steps of shutting down the discharge lamp, cooling the projection display apparatus for a predetermined period of time, stopping system cooling fans, shutting down the main power, setting an LED to a status indicating that the projection display apparatus is under a standby mode, etc.

In the description of the present invention, the password for activating the power shut-down procedure is a series of predetermined characters or symbols, e.g., ‘8,’ ‘9,’ ‘4,’ and ‘1.’ The number of the characters or symbols of a password is referred to a “length” of the password. The password may be stored with a character array with array size “length” in most of the conventional microcontrollers. In the above example, the password may be stored with a character array [8, 9, 4, 1] so the length of the password is 4. Each character of the password can be accessed via an index of the array. The 1^{st} index value is 0 instead of 1. Moreover, every button of a remote controller and a control panel is assigned to a corresponding character or symbol. The comparison of the user's input with the password is based on the assigned character corresponding to the input button of the remote controller or the control panel. The assigned character of each inputted button must consecutively match the character of the password one by one to pass the password identification procedure. For instance, the user should input ‘8,’ ‘9,’ ‘4,’ and ‘1,’ one by one in sequence via the remote controller or the control panel. Since the input is identical to the password in the above example, the password identification procedure is passed.

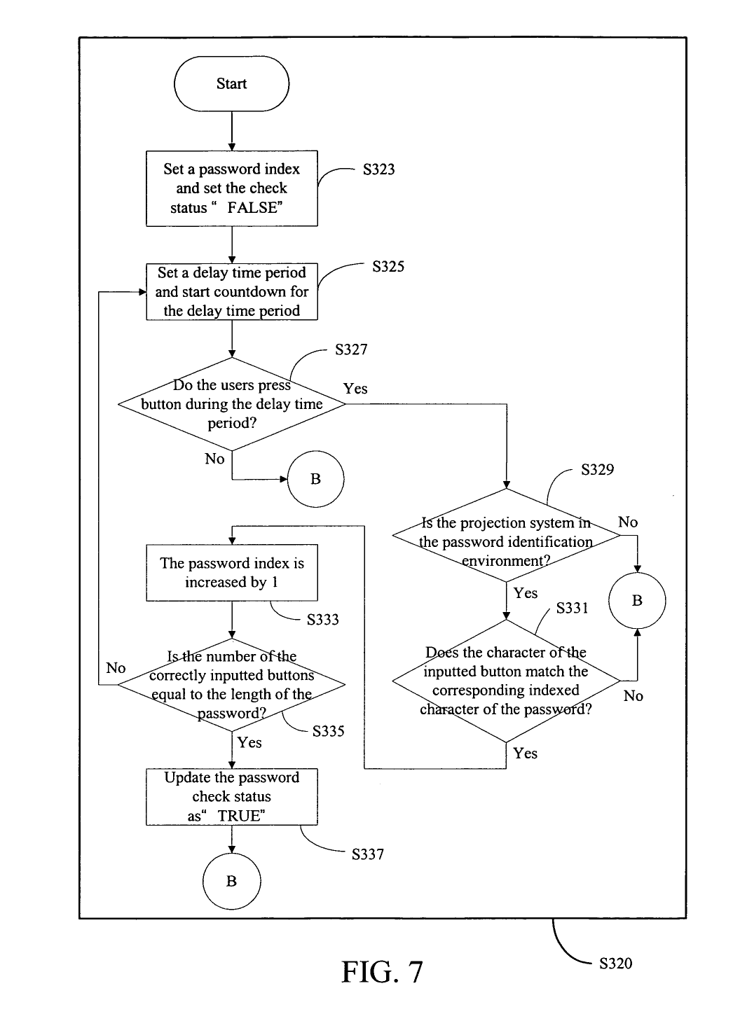

FIG. 7 is a flow chart of the password identification procedure in FIG. 6. In the password identification procedure of step S320, the projection display apparatus sets a password index as shown in step S323 and sets the check status to “FALSE.” In this embodiment, the initial value of the password index is related to the password identification procedure as described in steps S331/S335. According to this embodiment, the initial value of the password index is 0.

In step S325, the projection display apparatus sets a delay time period (e.g., 2 seconds) and starts countdown for the delay time period. As shown in step S327, the projection display apparatus detects whether the users press the button during the delay time period. If negative, the password identification procedure S320 is closed and returns to step S340 of FIG. 6. Since the password check status is still “FALSE,” the result of determination in step S340 is “No” so that users cannot enter the power shut-down procedure and the method is ended up. If the projection display apparatus detects that the users press the button to send out a signal during the delay time period, the password comparison is performed.

In step S329, the projection display apparatus checks whether it is in the password identification environment. The password identification environment can be defined by either setting a signal source to one of the AV inputs of the projection display apparatus according to requirements or setting the audio volume of the projection display apparatus to a default value. People skilled in this field can adjust these settings according to physical requirements. In this embodiment, the password identification environment is defined to set the default value of the volume to zero and set the signal source to the first AV input. If the projection display apparatus is not in the password identification environment, it will close the password identification procedure as step S329 and return to step S340 as shown in FIG. 6. In step S340, since the password check status is still “FALSE,” the power shut-down procedure cannot be activated and the method ends at the same time.

Please refer to FIG. 7, if the projection display apparatus is in the password identification environment, step S331 will be executed. In step S331, the password index is used to determine whether the assigned character of each of the input button is the same as the corresponding indexed character of the password. If any one of them is different, the password identification procedure is closed. If the character of the inputted button matches the corresponding indexed character of the password, step S333 is executed. In step S333, the password index is increased by one to generate a next password index.

Next, in step S335, determining whether the number of the correctly inputted buttons is equal to the length of the password. In this embodiment of the present invention, it is determined by the password index. Because the initial value of the password index is zero and the next password index will be generated every time when examining a button input been pressed, the password length should be relevant to the next password index. Taking a four-character password as an example, the password index corresponding to the fourth character is three. After examining the fourth character, the next generated password index should be four. Consequently, the next password index can be used to determine whether the password input is completed or not. In step S335, the next password index will be examined to determine whether it is equal to the length of the password. If the next password index is not equal to the length of the password, the process returns to step S325. If the next password index is equal to the length of the password, step S337 is executed to update the password check status as “TRUE” and returns to step S340 in FIG. 6. Because the password check status is “TRUE,” the result of step S340 is “Yes” so that step S350 is activated to start the power shut-down procedure.

In this embodiment, since the initial value of the password index is set to zero in step S323 in FIG. 7, the password index is increased by one every time when each inputted button is examined. People skilled in this field may of course set the initial value of the password index described in step S323 according to the length of password. The same purpose can also be achieved if step S333 is modified to decrease the password index by one every time when each inputted button is examined and step S335 is modified to examine whether the password index is zero or not.

In conclusion, the present invention has at least the following advantages:

1. When users operate the buttons of the remote controller or the control panel and press the power button inadvertently, the projection display apparatus will not shut down the projection lamp immediately. The users will have to input a confirmation signal to shut down the entire system. This prevents the projection display apparatus from shutting down the projection lamp due to inadvertent input(s) of power button and resulting in inconvenience for the users.

2. In the operation mode of shutting down the power by the password confirmation, when users inadvertently press or touch the power button of the remote controller of the projection display apparatus, the projection display apparatus will check at first whether it is in the password identification environment. The projection display apparatus will only check the input button(s) pressed by the users one by one when the projection display apparatus is in the password identification environment to see whether the input button(s) matches each character of the password. Each character of the password must be examined at each time. Since any incorrect comparison will prevent the projection display apparatus from entering the power shut-down procedure, the invention may greatly enhance the ability of preventing inadvertent input.

The above disclosure is related to the detailed technical contents and inventive features thereof. People skilled in this field may proceed with a variety of modifications and replacements based on the disclosures and suggestions of the invention as described without departing from the characteristics thereof. Although such modifications and replacements are not explicitly disclosed in the above descriptions, they are substantially falling within the scope of the following claims.

What is claimed is:

1. A projection display apparatus, comprising:
a display module for receiving a video signal and displaying an image;
a discharge lamp for emitting lights to project the image;
an activation circuit, coupled to the discharge lamp, for activating and shutting down the discharge lamp; and
a microcontroller for controlling the display module and the activation circuit according to a control signal;
wherein when the microcontroller receives two control signals for shutting down the projection display apparatus, the microcontroller controls the activation circuit to shut down the discharge lamp.

2. The projection display apparatus as claimed in claim 1, wherein the display module stops displaying the image corresponding to the video signal when the microcontroller receives a first control signal of the two control signals.

3. The projection display apparatus as claimed in claim 1, further comprising an audio module, electrically connected to the microcontroller, wherein the audio module stops outputting an audio signal when the microcontroller receives a first control signal of the two control signals.

4. The projection display apparatus as claimed in claim 1, further comprising a remote controller and a control panel, wherein a first control signal of the two control signals is generated by pressing a power button on one of the remote controller and the control panel.

5. The projection display apparatus as claimed in claim 1, further comprising a remote controller and a control panel, wherein a second control signal of the two control signals is generated by pressing a specific button rather than the power button on one of the remote controller and the control panel.

6. The projection display apparatus as claimed in claim 1, wherein the microcontroller starts a counting function for counting a predetermined time period in response to a first control signal of the two control signals.

7. The projection display apparatus as claimed in claim 6, wherein the microcontroller outputs a counting value to the display module to display a counting image and stops the counting function after the counting value is up to the predetermined time period.

8. A method for preventing an inadvertent input to shut down a discharge lamp of a projection display apparatus by a power shut down operation instruction, said method comprising the steps of:
receiving a power shut down signal;
detecting whether a confirmation signal is received; and
shutting down the discharge lamp if the confirmation signal is received.

9. The method as claimed in claim 8, wherein the receiving step comprises the step of activating a counting function for counting down a predetermined time period.

10. The method as claimed in claim 9, wherein the projection display apparatus generates a video output signal and an audio output signal and the receiving step comprises the step of shutting down one of the video output signal and the audio output signal.

11. The method as claimed in claim 10, further comprising:
determining whether a signal different from the confirmation signal is received within the predetermined time period; and
re-outputting one of the video output signal and the audio output signal if the signal is determined different from the confirmation signal.

12. The method as claimed in claim 8, wherein the receiving step comprises the step of displaying a counting down timer on a display screen of the projection display apparatus.

13. A method for preventing inadvertently activating a power shut down procedure of a projection display apparatus, comprising:
receiving a power shut down signal to activate a password identification procedure; and
activating the power shut down procedure if a check status of the password identification procedure is TRUE.

14. The method as claimed in claim 13, wherein the power shut down procedure comprises the step of shutting down a discharge lamp in advance.

15. The method as claimed in claim 13, wherein the password identification procedure comprises:
presetting the check status to FALSE;
setting a predetermined delay time period and counting down the predetermined delay time period;
detecting whether an input signal is received within the predetermined delay time period;
comparing each assigned character of the input signal with a corresponding indexed character of a password of the power shut down procedure when the input signal is received;
exiting from the password identification procedure if the assigned character of the input signal fails to match the corresponding indexed character of the password; and
setting the check status to TRUE if every character of the input signal matches the password.

16. The method as claimed in claim 15, wherein the password identification procedure further comprises:
determining if the projection display apparatus is in a password identification environment; and
exiting from the password identification procedure if the projection display apparatus is not in the password identification environment.

17. The method as claimed in claim 15, wherein the projection display apparatus exits from the password identification procedure if no input signal is received within the delay time period.

18. A method for preventing inadvertently shutting down a power of a projection display apparatus, comprising:
receiving an activation signal for entering a power shut down procedure;
setting a predetermined delay time period;
determining whether a confirmation signal is received within the predetermined delay time period;
entering the power shut down procedure if the confirmation signal is received within the predetermined delay time period; and
resuming to a normal display status of the projection display apparatus if the confirmation signal is not received or a signal different from the confirmation signal is received within the predetermined delay time period.

19. The method as claimed in claim 18, wherein the power shut down procedure comprises the step of shutting down a discharge lamp in advance.

20. The method as claimed in claim 18, wherein the activation signal and the confirmation signal are inputted by means of buttons of one of a remote controller and a control panel.

21. The method as claimed in claim 18, wherein the confirmation signal is a series of successive inputted characters which matches a password.
